(19) United States
(12) Patent Application Publication
(10) Pub. No.: US 2024/0303850 A1
(43) Pub. Date: Sep. 12, 2024

(54) METHOD FOR DETERMINING THE HEIGHT OF A TRAILER OF A MOTOR VEHICLE AND ELECTRONIC COMPUTING DEVICE

(71) Applicant: Daimler Truck AG, Leinfelden Echterdingen (DE)

(72) Inventors: Tobias Aurand, Freiberg (DE); Markus Zimmer, Leinfelden Echterdingen (DE)

(21) Appl. No.: 18/440,505

(22) Filed: Feb. 13, 2024

(30) Foreign Application Priority Data
Feb. 14, 2023 (DE) 10 2023 103 479.0

(51) Int. Cl. G06T 7/62; G06T 7/13

(52) U.S. Cl. CPC G06T 7/62; G06T 7/13

(57) ABSTRACT

The invention relates to a method for determining a height (H) of a trailer (12) of a motor vehicle (10), in which at least one image of a ground area (22) of the motor vehicle (10) is recorded by means of at least one first optical recording device (14a, 14b) and in which the image is evaluated by means of an electronic computing device (20) of the motor vehicle (10),

wherein a ground area (22a, 22b) to the side of the motor vehicle (10) is recorded, and a shadow boundary (G) of a shadow (24) of the trailer (12) on the ground area (22a, 22b) to the side is determined in the recording, and the height (H) is determined by means of the electronic computing device (20) as a function of a shadow length (L) of the shadow (24) relative to the motor vehicle (10). The invention also relates to an electronic computing device (20).

### CROSS-REFERENCE TO RELATED APPLICATIONS

This is a Paris Convention application, which claims priority to German application 10 2023 103 479.0, filed on Feb. 14, 2023, of which is hereby incorporated by reference in its entirety.

The present invention relates to a method for determining a height of a trailer of a motor vehicle according to the generic term of patent claim 1. The invention also relates to an electronic computing device.

The height or overall vehicle height of commercial vehicles in particular changes frequently due to changing loads or changing trailers/semi-trailers, sometimes several times in one day. This can lead to serious accidents, in particular if a load is higher than the base vehicle/cab and the driver is inattentive, for example under bridges that are lower than the standard height of 4 m. It is therefore helpful that the driver is warned in such a case and an accident is avoided. However, it is necessary to know the vehicle height for this.

DE 10 2004 028 763 A1, for example, already discloses a method for image data-based assistance for guiding a motor vehicle, in particular for maneuvering trucks to docking stations, in which image data is obtained from the surroundings of the motor vehicle by means of an imaging sensor. The relative position parameters of at least one potential destination in relation to the motor vehicle are extracted from the image data obtained and, as a result, a trajectory describing an optimized route is calculated for at least one of the potential destinations to support subsequent vehicle guidance. To extract the relative position parameters of the at least one potential destination, the image data is hereby subjected to edge detection and edge segmentation in order to break down the image data into individual edge segments, the relationships between which are stored in a mathematical tree structure. Furthermore, this method discloses additional steps for supporting vehicle guidance.

DE 10 2012 003 992 A1 also discloses a guidance system for a motor vehicle for driving up to a stationary object with pinpoint accuracy, for example for commercial vehicles when backing up to a loading ramp, a semi-trailer, a trailer or the like. The guidance system comprises at least one camera at the rear of the vehicle for detecting the rear environment of the vehicle and a characteristic, position-determining marking on the stationary object to be driven up to, as well as an electronic image processing device.

The object of the invention is to provide a method and an electronic computing device by means of which a height of a trailer of a motor vehicle can be determined.

This object is achieved by means of a method according to the invention with the features of claim 1 and by means of an electronic computing device according to the invention. Advantageous embodiments with appropriate further developments of the electronic computing device are to be regarded as advantageous embodiments of the method and vice versa. Advantages and advantageous embodiments of the invention are to be found in the dependent claims.

One aspect of the invention relates to a method for determining a height of a trailer of a motor vehicle, in particular a truck for transporting various high trailers, in which at least one image or at least one picture of a ground area of the motor vehicle is recorded by means of an optical recording device, in particular by means of a camera, in particular by means of a mirror cam. The image is evaluated by means of an electronic computing device of the motor vehicle, in particular by means of an on-board computer, whereby image processing programs are installed on the electronic computing device and are designed to process and evaluate the image by means of algorithms, models and other methods.

According to the invention, it is provided that a ground area to the side of the motor vehicle is recorded. A shadow of the trailer is thereby to be used to determine the height, whereby the shadow is generated due to solar radiation at an angle of light incidence of the solar radiation. This means that only the predetermined ground area to the side of the motor vehicle with the shadow can be used to determine the height, which means that larger areas, in particular entire recording areas of the optical recording device, are not necessary and therefore recording images with a small width is advantageous for the method, as less memory and computing capacity and fewer additional electronic components are required. In the image, a shadow boundary of a shadow of the trailer on the ground area to the side is determined, which is quickly and easily recognizable by a sharp change in color. The contrast of the colors at the shadow boundary means that the shadow boundary can be quickly recognized by an image processing program. In particular, a linear boundary is thus represented by the shadow boundary, which represents an upper edge or an upper edge of the trailer and whereby a height can be calculated using mathematical models by means of a relation of the motor vehicle to the shadow boundary. The height is to be calculated and thus determined as a function of a shadow length of the shadow relative to the motor vehicle by means of the electronic computing device and the image processing program, whereby simple geometric models can be used for this purpose. For this purpose, the angle of light incidence of the shadow cast at right angles to the motor vehicle is determined with the aid of previously recorded data on the position of the sun and the position of the vehicle. The desired height can then be determined as the opposite side using the formula height=tan(α)*shadow length. The height determined in this way can be considered directly as the desired maximum vehicle height.

In other words, the contrast between light and shadow, i.e., the shadow boundary, is determined, the distance of the motor vehicle to the shadow boundary is determined via the number of pixels or predefined relation sizes or a measured incidence of light. Based on this, the height of the trailer can be determined using a simple geometry. In particular, the angle of light incidence and the shadow length provide the data required to determine the height. Likewise, a number of pixels can be counted during the recording, which are necessary to get from the upper edge of the motor vehicle to the shadow boundary, which in turn is converted into a measurement unit and thus converts the number of pixels into a shadow length of the shadow, which also makes it possible to ascertain or determine the height. Finally, the number of pixels or a resulting pixel distance is converted into SI units and, in a final step, the distance is transmitted from the electronic computing device to the motor vehicle.

In other words, the detection device or camera takes a picture of the side area and analyzes the contrast boundary between dark and light, corresponding to the shadow of the trailer and the exposed residual area, in order to determine the shadow boundary. This boundary is recorded as a linear boundary and a distance of the shadow boundary relative to the motor vehicle is determined, which represents a distance based on the number of pixels, which in turn is transmitted to the motor vehicle in SI units in order to generate at least one signal for further procedures.

An advantageous embodiment of the invention provides for a plurality of images to be generated and evaluated. The plurality of images generates a large number of distances between the shadow boundary and the motor vehicle, by means of which a meridian is calculated and thus a more precise distance and therefore also a more precise height is determined. This allows external influences to be better corrected, especially in the case of diffuse shadows or ground with different contrasts, which can also be picked up by the detection device due to both weather and ground conditions, allowing the distance and thus the height to be calculated more accurately. This means that the images are also taken continuously, so that the calculation of the distance is carried out continuously and thus a more accurate determination of the height is possible. However, in the calculation mentioned above using the formula height=tan(α)*shadow length, it is advisable to average several measurements over a certain period of time in order to exclude random outliers due to incorrect influences such as incorrect optical detection of the shadow line. Accordingly, the plurality of images is advantageous in that the height can be calculated more accurately.

A further advantageous embodiment of the invention provides that an illumination device arranged on the motor vehicle is used during the method. The quality of the images is decisive for the calculation of the distance, which means that lighting the ground area improves the quality of the images. It is possible to improve the contrast or determine the angle of light incidence using an existing illumination device or an additional illumination device fitted to the motor vehicle. In particular, the illumination device can be adjusted so that the shadow of the trailer falls into the ground area to the side. For example, the illumination device can also be adjusted upwards and/or downwards by means of a telescopic rod or another device to change the height in the direction of the vehicle's height, thus allowing the shadow of the trailer to be adjusted. The height can now be determined depending on the angle of light incidence and the distance.

An embodiment of the invention in which further images are generated by means of a second detection device, which is arranged on a side of the motor vehicle opposite the first detection device and is also designed as a mirror cam and is arranged on a passenger-side exterior mirror of the motor vehicle, has also proved to be advantageous. Recording using a second mirror cam results in images being generated on both the driver's side and the passenger's side of the motor vehicle, making it possible to determine the shadow on both sides of the motor vehicle. Depending on the position of the sun, it is therefore easier to determine the height.

Finally, in a further advantageous embodiment of the invention, it is provided that the electronic computing device is electronically connected to a driver assistance system of the motor vehicle. The driver assistance system can use the height to help the driver of the motor vehicle when driving, maneuvering or reversing. In particular, a signal is generated by the electronic computing device and forwarded to an alarm device, whereby the alarm device generates an alarm which, for example, warns the driver and/or persons in the vicinity of the motor vehicle if the motor vehicle is too high for a tunnel or an underpass or other, whereby the motor vehicle can also brake at least partially autonomously. For example, the signal can now be used to start a warning that warns the driver that the trailer is too high, for example over four meters; alternatively, the signal can be used to adapt a driver assistance system to the newly determined height; in particular, the data is stored until the trailer is next changed and used for maneuvering or journeys.

A further aspect of the invention relates to an electronic computing device with processors and circuitry as well as software for carrying out a method according to the invention for determining a height of a trailer of a motor vehicle, by means of which at least one image of a ground area to the side of the motor vehicle, taken by means of an optical detection device, can be evaluated to determine the height.

In other words, it is provided according to the invention that the vehicle height and/or a vehicle length can be determined via the shadow cast, which is determined by a detection device or mirror cam in combination with knowledge of a vehicle position relative to the position of the sun and thus knowledge of the angle of light incidence, both azimuth and elevation of the sun. With the help of a measurement of the shadow by the detection device and the aforementioned data, it is then possible to calculate how high the load or the semi-trailer or trailer of the vehicle is. If the vehicle is also equipped with a system to determine the clearance height under height obstacles, for example by means of a front camera, a driver assistance system can improve at least semi-autonomous driving of the motor vehicle and make it safer. A comparison of the vehicle height and clearance height can be used to warn the driver if the vehicle height is exceeded or even to initiate emergency braking. It is also possible that as soon as a change in vehicle height is detected, the driver is provided with the information in a display device, for example: “Attention: change in vehicle height detected. Vehicle is at least X m high. Pay attention to height obstacles.”

In order to further improve the quality of the results, the system is designed to further exclude systematic fault effects. This prevents the shadow of an unknown other light source from being misinterpreted as a shadow cast by the sun. This is only possible, for example, by activating the system outdoors and at times when the sun is sufficiently high. Furthermore, other external influences can be prevented from distorting the measurement. For this purpose, the existing data from the monitoring of surrounding traffic, for example by the radar sensors, can be used to rule out the possibility of surrounding traffic distorting the measurement result. Unrealistic vehicle heights that are clearly outside the usual vehicle profile of minimum and maximum height should be interpreted as incorrect measurements and excluded from further processing.

To validate the maximum height determined, the shadow cast by the driver's cab can also be used when the sun is in a favorable position, as this fixed value is known to the system. It would also be possible to use the cab height to determine the trailer height. A favorable position of the sun here means a constellation in which the shadow of the driver's cab also falls within the recording range of the optical detection device and can be distinguished from the shadow of the rest of the vehicle.

Likewise, a measurement when driving straight ahead can be considered more meaningful because it rules out the additional influences of an increased vehicle inclination with an angle of inclination in a pitching direction of the vehicle and the trailer being at an angle to the motor vehicle. The system can also take this into account by incorporating the data available from the steering angle when selecting favorable measurement times.

The determined height can be shown as optional information for the driver on a display device. In order to also communicate the quality of the displayed measurement data, the time at which the heights were last validly determined can also be displayed, from which the driver can see whether the vehicle body he is using is up to date.

In a further embodiment, a new vehicle height determination can also be triggered by detecting when a new semi-trailer or trailer is hitched up. For example, the status of a semi-trailer coupling or the detection of an initially interrupted and then re-established electrical connection from the vehicle to a trailer or semi-trailer could be used here.

Furthermore, valid information about the height can be used directly as input for other assistance systems. This allows the height to be compared with the clearance height in front of the vehicle. If necessary, an additional visual and audible warning is issued to the driver: “Height exceeds clearance height ahead!”. If there is an acute risk of an accident due to the excessive height, automated braking can also be initiated, including emergency braking of the vehicle.

Further advantages, features and details of the invention are apparent from the following description of preferred embodiments and from the drawings. The features and combinations of features mentioned above in the description as well as the features and combinations of features mentioned below in the description of the figures and/or shown alone in the figures can be used not only in the combination indicated in each case, but also in other combinations or on their own, without departing from the scope of the invention.

In the drawings:

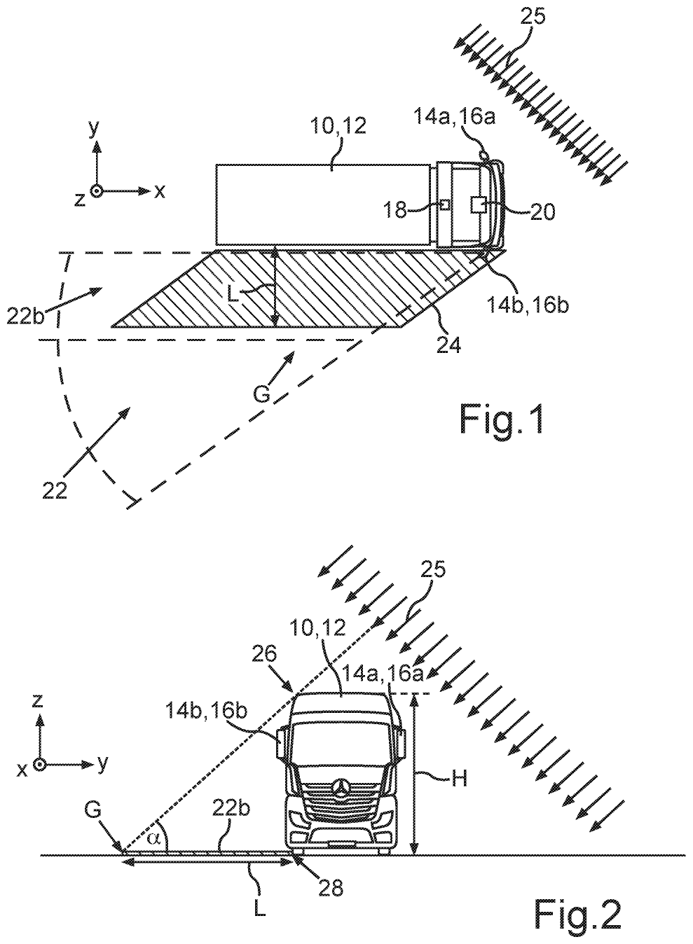

FIG. 1 shows a schematic top view of a motor vehicle with a trailer, on which a height is determined using a trailer shadow by means of the method according to the invention; and

FIG. 2 shows a schematic front view of the motor vehicle to illustrate a geometry used to determine the height by the method according to the invention.

Identical or functionally identical elements are marked with the same reference signs in the figures.

FIG. 1 shows a schematic top view of a motor vehicle 10, in particular a truck with a trailer 12, which together represent a body of the motor vehicle 10. The motor vehicle 10 comprises at least one optical detection device 14a, in particular two optical detection devices 14a, 14b, one on the driver's side to the left in the longitudinal direction x of the vehicle and the other on the passenger's side and thus to the right of the motor vehicle 10 in the longitudinal direction x of the vehicle, as well as a first exterior mirror 16a on the driver's side and a second exterior mirror 16b on the passenger's side which differs from the first exterior mirror 16a and on which the optical detection devices 14a, 14b are arranged, the optical detection devices 14a, 14b being designed as mirror cams. In particular, the optical detection devices 14a, 14b and an illumination device 18 are electronically coupled to an electronic computing device 20, in particular for carrying out the method according to the invention for determining a height H of the trailer 12.

In the method for determining the height H of the trailer 12 of the motor vehicle 10, at least one image of a ground area 22a, 22b of the motor vehicle 10 is recorded by means of at least one of the optical detection devices 14a, 14b and in which the image is evaluated by means of the electronic computing device 20, in particular a plurality of images is generated and evaluated, whereby a plurality of values and information can be recorded. A shadow 24 of the trailer 12 is thereby to be used to determine the height H, whereby the shadow 24 is generated due to solar radiation 25 at an angle of light incidence a of the solar radiation 25. The optical detection device 14a, 14b used here records the ground area 22a, 22b to the side of the motor vehicle 10, wherein in FIG. 1 the shadow 24 of the trailer 12 falls on the passenger-side ground area 22b and

wherein a shadow boundary G of the shadow 24 on the one ground area 22b to the side is determined in the recording, in particular by means of color contrasts between light and dark or shadow and light, whereby the shadow boundary G is detected as a linear boundary. In FIG. 1, the focus here is on the passenger-side ground area 22b; the driver-side ground area 22a is not shown in this example due to the solar radiation 25, but a mirror-symmetrical design would also be possible depending on the solar radiation 25. Depending on a shadow length L of the shadow 22 relative to the motor vehicle 10, the height H is determined using a predefined geometry or geometric models by means of the electronic computing device 20. In particular, the plurality of images is intended to generate different distances between shadow boundary G and motor vehicle 10 and thus a plurality of shadow lengths L, by means of which a meridian is calculated and thus a more accurate shadow length L and thus also a more accurate height H is determined. This allows external influences to be better corrected, especially in the case of diffuse shadows 24 or ground with different contrasts, which can also be picked up by the detection device due to both weather and ground conditions, allowing the distance and thus the height H to be calculated more accurately.

In other words, the motor vehicle 10 casts a shadow 24 on the ground area 22 of the motor vehicle 10, wherein a shadow 24 cast by the motor vehicle 10 falls on a ground area 22a, 22b to the side due to an angle of light incidence a of the sun and is picked up by the respective optical detection device 14a, 14b. The height H is determined by determining the shadow length L via a geometry using the electronic computing device 20 and made available to the motor vehicle 10. The contrast between light and shadow, namely the shadow boundary G, represents the distance of the motor vehicle 10 to the shadow boundary G; the shadow length L can be determined on the image via a number of pixels or predefined relation sizes or via a measured incidence of light. Based on this, the height of the trailer can be determined using a simple geometry. In particular, the angle of light incidence and the shadow length L provide the data required to determine the height H. Similarly, the image can be used to check the number of pixels required to reach the shadow boundary G from the motor vehicle 10 and thus represent the shadow length L, which in turn is converted into an SI unit, whereby the height H is now determined in SI units.

FIG. 2 shows a schematic front view of the motor vehicle 10 to illustrate the geometry used to determine the height H by the method according to the invention. The core of the invention is the possibility of using images from the optical detection devices 14a, 14b, which are already installed as standard in the motor vehicle 10, have a fixed position and angle and are known as mirror cams. Although the respective optical detection device 14a, 14b does not directly cover an upper edge 26 of the trailer 12, it does record a lower edge 28 and a road area or the ground area 22, in particular the passenger-side ground area 22b to the side next to the motor vehicle 10, very well. It is precisely this ground area 22b to the side where the shadow is cast due to the solar radiation 25 during daytime driving and when the sun is sufficiently high. Since an exact position of the sun in the sky relative to the motor vehicle 10 can be precisely determined based on knowledge of the date, time and GPS position of the motor vehicle, in particular using the electronic computing device 20, an expected shadow direction relative to the position of the sun can be determined with the aid of an exact vehicle position and orientation, which can be determined using a compass and/or also using a GPS and/or using other localization means. In other words, in this expected shadow direction, the shadow length L of the shadow cast can be determined at right angles starting from an outer edge of a vehicle body of the motor vehicle 10 at a road level, represented by the upper edge 26, by means of an automated evaluation of the at least one image of the corresponding vehicle side. Using the trigonometric laws, the required height H can be determined from this value and the angle of light incidence a of the sun in the front view of the motor vehicle 10 shown in FIG. 2.

For this purpose, the angle of light incidence a of the shadow cast at right angles to the motor vehicle 10 is determined with the aid of previously named known data on the position of the sun and the position of the vehicle. The desired height H can then be determined as the opposite side using the formula H=tan(α)*D. The height H determined in this way can be considered directly as the desired maximum vehicle height. However, it is recommended to average several measurements over a certain period of time in order to exclude random outliers due to incorrect influences such as an incorrect optical detection of the shadow line.

In particular, the illumination device 18 can be used as a further light source during the method. The quality of the images is decisive for the calculation of the distance, which means that lighting the ground areas 22a, 22b to the side improves the quality of the images. It is possible to improve the contrast or determine the angle of light incidence a using an existing illumination device 18 or an additional illumination device 18 fitted to the motor vehicle 10. In particular, the illumination device 18 can be adjusted so that the shadow 24 of the trailer 12 falls into the ground area 22a, 22b to the side. For example, the illumination device 18 can also be adjusted upwards and/or downwards by means of a telescopic rod or another device to change the height in the direction of the vehicle's height z, thus allowing the shadow 24 of the trailer 12 to be adjusted. The height can now be determined depending on the angle of light incidence a and the distance.

### LIST OF REFERENCE SIGNS

10 Motor vehicle
12 Trailer
14a, 14b Optical detection device
16a, 16b Exterior mirror
18 Illumination device
20 Electronic computing device
22 Ground area
22a, 22b Ground area to the side
24 Shadow
25 Solar radiation
26 Upper edge
28 Lower edge
H Trailer height
G Shadow boundary
L Shadow length
α Angle of light incidence
x Longitudinal direction of the vehicle
y Transverse direction of the vehicle
z Direction of the vehicle's height

1. Method for determining a height (H) of a trailer (12) of a motor vehicle (10), in which at least one image of a ground area (22) of the motor vehicle (10) is recorded by means of at least one optical detection device (14a, 14b) and in which the image is evaluated by means of an electronic computing device (20) of the motor vehicle (10),
characterized in that
a ground area (22a, 22b) to the side of the motor vehicle (10) is recorded, and a shadow boundary (G) of a shadow (24) of the trailer (12) on the ground area (22a, 22b) to the side is determined in the recording and the height (H) is determined by means of the electronic computing device (20) as a function of a shadow length (L) of the shadow (24) relative to the motor vehicle (10).

2. Method according to claim 1,
characterized in that
a plurality of images is generated and evaluated by means of the optical detection device (14a, 14b).

3. Method according to claim 1,
characterized in that
an illumination device (18) arranged on the motor vehicle (10) is used during the method.

4. Method according to claim 1,
characterized in that
further images are generated by means of a further optical detection device (14b) on a passenger-side exterior mirror (16b) of the motor vehicle (10).

5. Method according to claim 1,
characterized in that
electronic computing device (20) is electronically connected to a driver assistance system of the motor vehicle (10).

6. Electronic computing device (20) with processors and circuitry as well as software for carrying out a method according to the invention for determining a height (H) of a trailer (12) of a motor vehicle (10), by means of which at least one image of a ground area (22a, 22b) to the side of the motor vehicle (10) taken by means of an optical detection device (14a, 14b) can be evaluated to determine the height (H).
